(19) United States
(12) Patent Application Publication
(10) Pub. No.: US 2015/0334252 A1
(43) Pub. Date: Nov. 19, 2015

(54) SYSTEMS AND METHODS FOR REDUCING SIGNALLING IN AN INTERNET PROTOCOL TELEPHONY SYSTEM

(71) Applicant: VONAGE NETWORK, LLC, HOLMDEL, NJ (US)

(72) Inventors: KEVIN HUANG, PRINCETON JUNCTION, NJ (US); JAYA MEGHANI, OLD BRIDGE, NJ (US); ZHIYU GUO, EAST BRUNSWICK, NJ (US); BOAZ ZEHAVI, JERSEY CITY, NJ (US)

(73) Assignee: VONAGE NETWORK, LLC, HOLMDEL, NJ (US)

(21) Appl. No.: 14/279,552

(22) Filed: May 16, 2014

(51) Int. Cl. H04M 17/00; H04M 7/12; H04W 28/02

(52) U.S. Cl. CPC H04M 17/10; H04M 17/201; H04M 17/106; H04W 28/0215; H04M 7/1275; H04M 2017/26; H04M 2017/222

(57) ABSTRACT

A system and method for charging a prepaid account for telephony services reserves portions of a balance of the prepaid account to pay for telephony services that have been requested by a user. Once the final charges for providing the telephony services are known, the balance is reduced by the amount of the actual charges, and any portion of the reserved amount is released.

### BACKGROUND OF THE INVENTION

The invention is related to telephony communications systems. More specifically, the invention is related to methods performed by an IP telephony system to charge a prepaid account for providing telephony services

There are multiple different types of prepaid accounts that could be used to pay for telephony services. In some instances, a user could purchase a calling card in a retail establishment for a certain amount of money, and the prepaid calling card would be associated with an account with a telephony services provider. The telephony services provider then provides telephony services to the user, and charges the prepaid account for those telephony services. The prepaid account starts with a balance equal to the original purchase price of the calling card. As the user obtains or uses telephony services, charges for such usage gradually reduce the balance of the prepaid account.

In other instances, a user may open an account with a telephony services provider and make an initial payment to put value into the account. Such a transaction could be conducted online or over the telephone with the assistance of a live or automated attendant. Of course, a user could establish a prepaid account with a telephony services provider in other ways. Here again, as telephony services are provided to the user, the prepaid account is charged for the cost of those telephony services, thereby reducing the balance of the prepaid account.

In some instances, it may be possible for a user to add additional value to a prepaid account after an initial purchase or charge has been made to establish the prepaid account, and after the balance of the account has been reduced by usage. Additional value could be added via credit card charges that are initiated via an Internet interface, via a telephone based interface, or by speaking with a live operator or an automated attendant. Of course additional value could be added to an existing prepaid account in other ways.

Each time that a user requests telephony services that are to be paid for via a prepaid account, it is necessary for the telephony service provider to first verify that the current balance of the prepaid account is positive. Also, as telephony services are provided to the user, such as while a telephone call is ongoing, the telephony services provider must monitor the accrued charges for providing the telephony services to ensure that the accrued charges do not exceed the available balance of the user's prepaid account. If the accrued charges ultimately equal the available balance of the user's prepaid account, the telephony service provider usually terminates the telephony services. In some instances, the telephony services provider may provide one or more warnings as the accrued charges approach the available balance of the user's prepaid account to avoid suddenly terminating an ongoing telephone call without warning.

If only a single user is able to utilize a prepaid account to pay for conducting a single telephone call at any given time, it is relatively easy to track the prepaid account balance and the accrued charges for conducting a telephone call. At the beginning of the telephone call, one or more elements of the telephony system responsible for setting up and carrying the call could obtain the starting balance of the prepaid account. Those elements of the telephony system could thereafter monitor the accrued charges for conducting the call to ensure that the accrued charges do not exceed the original prepaid account balance.

However, the process of monitoring the balance of a prepaid account and comparing it to accrued charges for providing telephony services becomes considerably more complex if more than one party can use the same prepaid account to pay for telephony services that are delivered simultaneously. Under those circumstances, two or more users could be simultaneously conducting telephone calls that are to be paid for using the balance in the same prepaid account. Because of this fact, one cannot simply start with the balance of the prepaid account, and then monitor the accrued charges for a single ongoing call to ensure the accrued charges do not exceed the starting balance of the prepaid account. Instead, accrued charges for all simultaneously ongoing calls must be frequently reported to the management system responsible for managing the balance of the prepaid account. Those accrued charge reports for all the simultaneously ongoing calls are used to simultaneously reduce balance of the single prepaid account. When the balance of the prepaid account approaches zero, messages must be sent out to all elements responsible for the multiple ongoing calls so that warnings can be issued to all simultaneous users, and so that all simultaneous ongoing calls can be terminated when the prepaid account balance hits zero.

The process of monitoring the accrued charges for multiple ongoing calls that are to be charged to the same prepaid account requires frequent messages to be sent from the elements responsible for setting up and conducting the calls to the elements responsible for monitoring and managing the balance of prepaid accounts. Likewise, if the prepaid account balance approaches zero, multiple messages must be sent from the elements responsible for monitoring and managing the balance of prepaid accounts to the elements responsible for setting up and conducting the multiple ongoing calls. This message traffic is basically undesirable overhead, as the message traffic itself does not provide any services directly to customers. Thus, it is desirable to minimize such overhead message traffic as much as possible.

### BRIEF DESCRIPTION OF THE DRAWINGS

FIG. 1 is a diagram of a communications environment including various elements which are associated with an Internet protocol (IP) telephony system in accordance with an embodiment of the invention;

FIG. 2 is a diagram of various elements of a processor that forms part of an IP telephony system or an IP telephony device according to an embodiment of the invention;

FIG. 3 is block diagram illustrating how various elements located in multiple different countries can interact to provide telephony services that are to be charged to a prepaid account;

FIG. 4 is a block diagram of various elements of a prepaid account charge unit;

FIG. 5 is a flowchart illustrating steps of a first method that would be performed by a prepaid account management unit to charge a prepaid account for providing telephony services;

FIG. 6 is a flowchart illustrating steps of a second method that would be performed by a prepaid account management unit to charge a prepaid account for providing telephony services;

FIG. 7 is a flowchart illustrating steps of a third method that would be performed by a prepaid account management unit to charge a prepaid account for providing telephony services; and

FIG. 8 is a flowchart illustrating steps of a method that would be performed to reserve portions of a prepaid account that is to be used to pay for telephony services.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

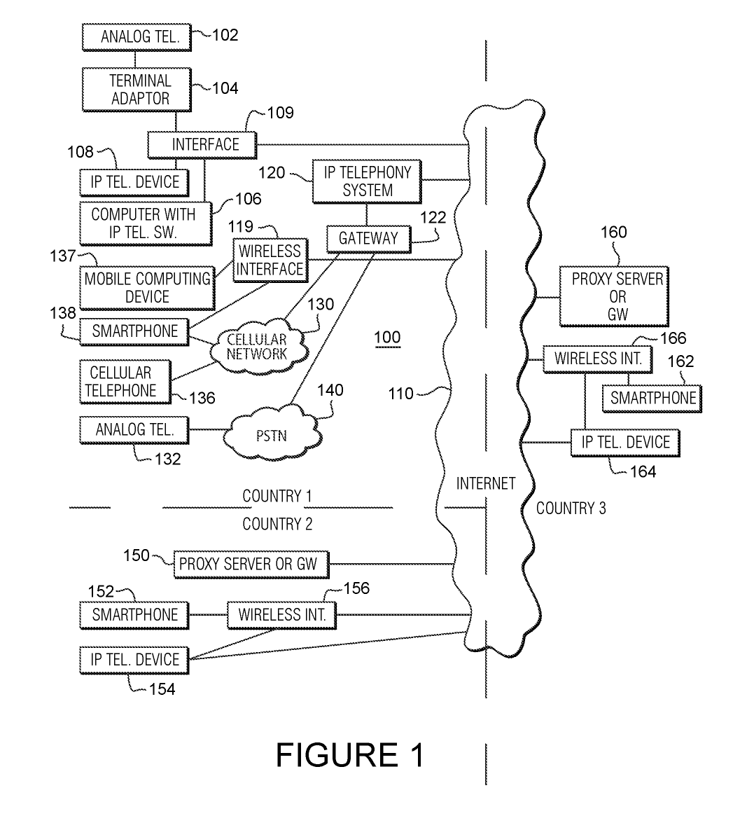

As illustrated in FIG. 1, a communications environment 100 is provided to facilitate IP based communications. An IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to a publicly switched telephone network (PSTN) 140 and/or a cellular network 130 via one or more gateways 122.

The gateway 122 allows users and devices that are connected to the PSTN 140 or cellular network 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110 via a data network interface 109. The IP telephone 108 could be connected to the data network interface 109 via a wired or wireless connection.

Alternatively, a customer could utilize a normal analog telephone 102 which is connected to the Internet 110 via a terminal adapter 104 and the data network interface 109. The terminal adapter 104 converts analog signals from the telephone 102 into data signals that pass over the Internet 110, and vice versa. Analog telephony devices include, but are not limited to, standard telephones and document imaging devices such as facsimile machines. A configuration using a terminal adapter 104 is common where the analog telephone 102 is located in a residence or business

In addition, a customer could utilize a computer that is running IP telephony software 106 to place and receive IP based telephone calls, and to access other IP telephony systems (not shown). Here again, the computer running IP telephony software 106 would access the Internet 110 via the data network interface 109. In some instances, the IP telephony software could be assigned its own telephone number. In other instances, the IP telephony software could be associated with a telephone number that is also assigned to an IP telephone 108, or to a terminal adaptor 104 that is connected to an analog telephone 102.

In addition, a mobile computing device 137 which is running IP telephony software also could be used to place and receive telephone calls through the IP telephony system 120. The mobile computing device 137 accesses the Internet 110 via a wireless data network interface 119. The wireless data network interface could be a WiFi or WiMax router, or any other type of wireless data interface device capable of communicating wirelessly with the mobile computing device 137.

A third party using an analog telephone 132 which is connected to the PSTN 140 may call a customer of the IP telephony system 120. In this instance, the call is initially connected from the analog telephone 132 to the PSTN 140, and then from the PSTN 140, through the gateway 122 to the IP telephony system 120. The IP telephony system 120 then routes the call to the customer's IP telephony device. A third party using a cellular telephone 136 could also place a call to an IP telephony system 120 customer, and the connection would be established in a similar manner, although the first link would involve communications between the cellular telephone 136 and a cellular telephone network 130.

A smart phone 138 which includes cellular telephone capabilities could also be used to conduct telephony communications through both the IP telephony system 120 and the cellular network 130. For example, an IP telephony software application running on the smart phone 138 could communicate with the IP telephony system 120 via the Internet 110. The smart phone 138 could access the Internet 110 via the wireless data network interface device 119, or via a data channel of the cellular network 130. Of course, alternate embodiments could utilize any other form of wired or wireless communications paths to enable communications.

Users of the IP telephony system 120 are able to access the service from virtually any location where they can connect to the Internet 110. Thus, a customer could register with an IP telephony system in the U.S., and that customer could then use an IP telephone 108 located in a country outside the U.S. to access the services. Likewise, the customer could also utilize a computer outside the U.S. that is running IP telephony software to access the IP telephony system 120. Further, in some instances a user could place a telephone call with the analog telephone 132 or the cellular telephone 136 that is routed through the PSTN 130 or cellular network 140 to the IP telephony system 120 via the gateway 122. This would typically be accomplished by the user calling a local telephone number that is routed to the IP telephony system 120 via the gateway 122. Once connected to the IP telephony system 120, the user may then place an outgoing long distance call to anywhere in the world using the IP telephony system 120 network. Thus, the user is able place a long distance call using lower cost IP telephony service provided by the IP telephony system 120, rather than a higher cost service provided by the PSTN 140 or cellular network 130.

FIG. 1 also illustrates that a user having a smartphone 152 in a second country is able to access the services of the IP telephony system 120 via the Internet 110. The smartphone 152 could connect to the Internet 110 via a wireless interface 156. Similarly, an IP telephony device 154 is also able to access the Internet 110 via the wireless interface 156 to obtain the services of the IP telephony system 120. This means that users of the smartphone 152 and IP telephony device 154 in the second country can place outgoing calls and receiving incoming calls that are routed through the IP telephony system 120.

FIG. 1 also illustrates that a proxy server or gateway 150 may be located in the second country. The proxy server or gateway 150 may be responsible for setting up calls for the smartphone 152 and IP telephony device 154 located in the second country. Having a locally based proxy server or gateway in the second country may make it possible to setup and new calls more rapidly and with higher call quality than would be possible if telephony devices located in the second country need to communicate with a proxy server or gateway located in a different country in order to access the telephony services provided by the IP telephony system 120.

In some embodiments, a proxy server or gateway 150 located in the second country could be owned and operated by the IP telephony system 120, which is based in the first country. Alternatively, the proxy server or gateway 150 could be owned and operated by a third party, and the IP telephony system 120 could pay to have access to the proxy server or gateway 150.

As also illustrated in FIG. 1, a proxy server or gateway 160 located in a third country could be used to help setup and route calls through the IP telephony system 120 for a smartphone 162 and IP telephony device 164 located in the third country that connect to the Internet 110 via a wireless interface 166 in the third country.

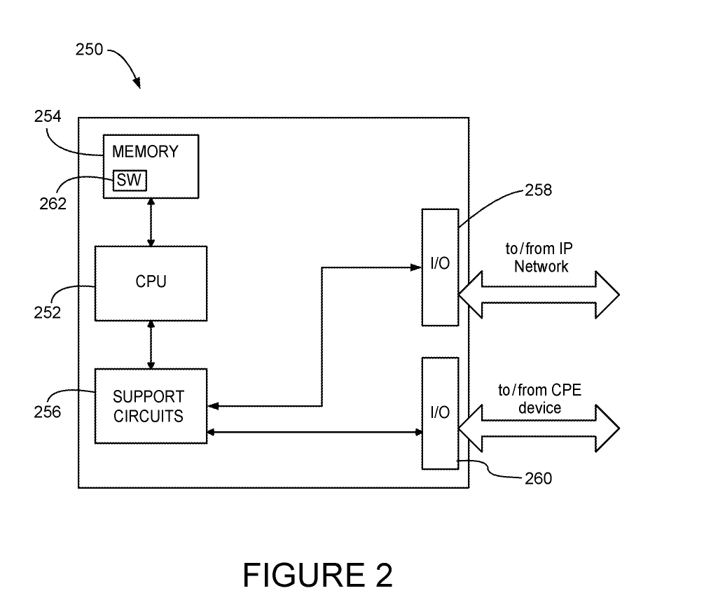

FIG. 2 illustrates elements of a computer processor 250 that can be used as part of the IP telephony system 120 or a telephony device to accomplish various functions. The IP telephony system 120 could include multiple processors 250 located at various locations in the system, along with their operating components and programming, each carrying out a specific or dedicated portion of the functions performed by the IP telephony system 120.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to and IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

References to an “IP telephony device” appear in both the foregoing and following descriptions. This term is used to refer to any type of device which is capable of interacting with an IP telephony system to conduct a communication. An IP telephony device could be an IP telephone, a computer running IP telephony software, a telephone adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch™ can interact with an IP telephony system to conduct a telephone call.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

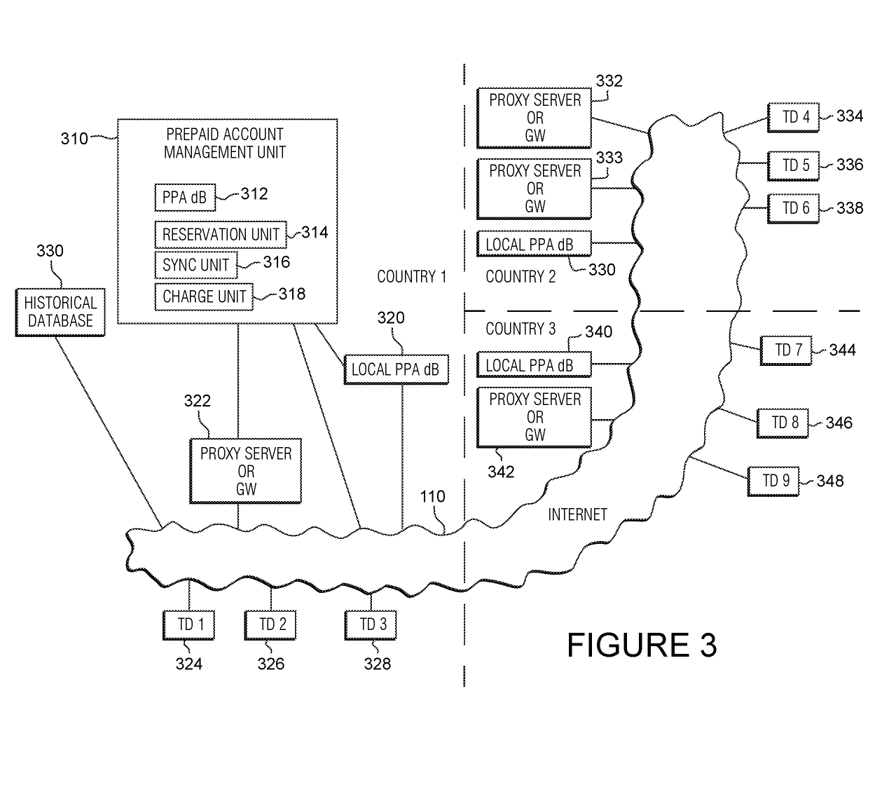

FIG. 3 is a block diagram illustrating various elements that are involved in managing and charging prepaid accounts used to purchase telephony services. In some embodiments, the telephony services are provided by an IP telephony system, such as the one illustrated in FIG. 1. In alternate embodiments, the telephony services could be provided by a different type of telephony service provider.

In the following examples, telephony services purchased via a prepaid account are provided by an IP telephony system. However, this should in no way be considered limiting, as the telephony services could be provided by a different type of telephony service provider.

FIG. 3 illustrates that first, second and third telephony devices 324, 326, 328 are located in a first country, and are coupled to the Internet 110. The telephony devices 324, 326, 328 could be any type of telephony device capable of interacting with an IP telephony system, such as the ones illustrated in FIG. 1 and discussed above. The telephony devices 324, 326, 328 could access the Internet 110 via any means, such as a wired or wireless interface, or via a data channel provided by a cellular service provider.

One or more proxy servers or gateways 322 are also provided in the first country. Although only a single proxy server or gateway 322 is shown in FIG. 3, in most instances, many proxy servers or gateways would be present. The telephony devices 324, 326, 328 contact the proxy server or gateway 322 in order to request and setup a new telephony communication. Alternatively, if an IP telephony system is attempting to connect a telephony communication to one of the telephony devices 324, 326, 328, the IP telephony system could instruct the proxy server or gateway 322 to contact one of the IP telephony devices 324, 326, 328 to setup the new telephony communication.

A prepaid account management unit 310 is also located in the first country. The prepaid account management unit 310 includes a prepaid account database 312 which tracks the balances of multiple prepaid accounts that have been established by users with a telephony service provider. As noted above, such accounts could be established and funded in multiple different ways. In some instances, the prepaid account management unit 310 and the associated prepaid account database 312 would be associated with only a single telephony service provider. In alternate embodiments, multiple different telephony service providers could be serviced by a single prepaid account management unit 310 and its associated prepaid account database 312.

Also, in some instances the prepaid account database 312 may be only a single database, whereas in alternate embodiments, multiple prepaid account databases could be provided. Where multiple prepaid account databases are provided, each prepaid account database 312 could relate to different types of accounts, different types of users, users in different geographical locations, or different telephony service providers. Of course, the prepaid account databases could be split up in other ways. For example, one prepaid account database could track prepaid accounts that have been funded in a first currency, whereas a second prepaid account database could track prepaid accounts funded in by a second, different currency.

The prepaid account management unit 310 also includes a reservation unit 314 that reserves one or more portions of the balance of a prepaid account, as will be described in detail below. A charge unit 318 is responsible for charging a prepaid account for telephony services that are provided to users.

A synchronization unit 316 is responsible for synchronizing the information stored in multiple copies of a single database. For example, FIG. 3 illustrates that a first local copy of prepaid account databases 320 may be located in the first country, a second local copy of prepaid account databases 330 may be located in a second country, and a third local copy of the prepaid account databases 340 may be located in a third country. Besides serving as geographically distributed backups, the local copies of the prepaid account databases 320, 330, 340 may be accessed by elements of a telephony system when a user requests new telephony services to determine if the user's prepaid account has a sufficiently large balance to allow the telephony system to provide newly requested telephony services. The synchronization unit 316 of the prepaid account management system 310 is responsible for periodically synchronizing the information stored in the various copies of the prepaid account databases.

FIG. 3 also illustrates that a historical database 330 may be provided to track information about an individual user's telephony services usage patterns. As will be explained in detail below, this information could be used by the reservation unit 314 of the prepaid account management unit 310 to determine how much of the outstanding balance of a prepaid account one should reserve to pay for newly requested telephony services.

FIG. 3 also illustrates that two proxy servers or gateways 332, 333 are located in the second country. Fourth, fifth and sixth telephony devices 334, 336, 338 located in the second country will contact the proxy servers or gateways 332, 333 to request and setup new telephony communications. Likewise, if an IP telephony system is attempting to setup a new telephony communication to any of the fourth, fifth or sixth telephony devices 334, 336, 338, one of the proxy servers or gateways 332, 333 may contact one of the telephony devices 334, 336, 338 to setup the new telephony communication.

Similarly, a proxy server or gateway 342 is located in the third country, as are seventh, eighth, and ninth telephony devices 344, 346, 348. The telephony devices 344, 346, 348 contact the proxy server or gateway 342 to request and setup new telephony communications. Likewise, if an IP telephony system is attempting to setup a new telephony communication to any of the telephony devices 344, 346, 348 in the third country, the proxy server or gateway 342 may contact one of the telephony devices 344, 346, 348 to setup the new telephony communication.

Although FIG. 3 illustrates that telephony devices within a country communicate with a proxy server or gateway within the same country to setup new telephony communications, in alternate embodiments, a telephony device in a first country could communicate with a proxy server or gateway located in a different country to setup new telephony communications. Thus, the arrangement illustrated in FIG. 3 should in no way be considered limiting.

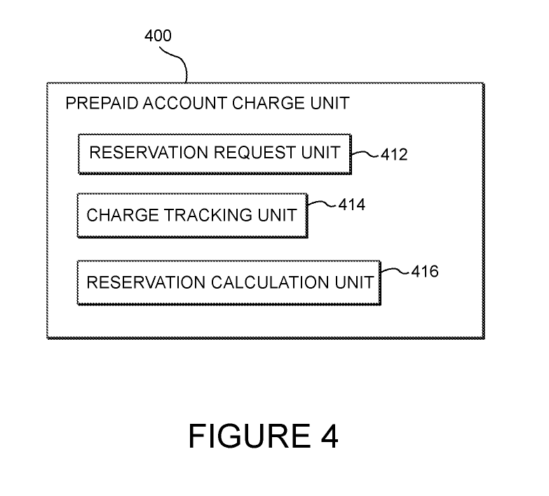

FIG. 4 illustrates elements of a prepaid account charge unit 410 that is configured to cause a prepaid account to be charged for the provision of telephony services. The prepaid account charge unit 410 communicates with a prepaid account management unit 310, such as the one illustrated in FIG. 3, to cause such charges to be lodged. All or a portion of the prepaid account charge unit 410 could be resident on a proxy server or gateway that is responsible for setting up new telephony communications to telephony devices. Alternatively, all or a portion of a prepaid account charge unit 410 could be resident on a media relay that is used to conduct a telephony communication. In still other embodiments, all or a portion of a prepaid account unit 410 could be resident on a telephony device, such as an IP telephony device. In some embodiments, different portions of a prepaid account charge unit 410 could be split between a telephony device, a media relay, a proxy server or gateway, or some other element of a telephony system.

The prepaid account charge unit 410 includes a reservation request unit 412 that is configured to send a request to reserve a portion of a balance of a prepaid account to a prepaid account management unit 310, as will be described in detail below. A charge tracking unit 414 monitors the accrued charges for telephony services that are being provided to users. In some embodiments, the prepaid account charge unit 410 may also include a reservation calculation unit 416 that is configured to calculate or determine how much of a balance of a prepaid account should be reserved to pay for a requested telephony service. If this information is developed by a reservation calculation unit 416 of a prepaid account charge unit 410, the information may be included in a reservation request that is sent to a prepaid account management unit 310 by the reservation request unit 412, as will also be discussed below.

The elements described above perform methods of managing and charging prepaid accounts for the provision of telephony services. The methods are designed to reduce the amount of message traffic needed to accomplish these tasks, as compared to other known methods. The basic overall concept is to reserve a portion of the current balance of a prepaid account for purposes of paying for a newly requested telephony service when a request for those telephony services is received. The telephony system then begins to provide the telephony services to the requesting party. As the telephony system continues to provide the telephony services, elements of the telephony system calculate and monitor the total accrued charges for providing the telephony services. So long as the accrued charges do not exceed the original reserved amount, the telephony system will continue to provide the services. If the telephony services are discontinued or terminated before the accrued charges exceed the original reserved amount, the balance of the prepaid account is reduced by the amount of the accrued charge, and any remaining portion of the original reserved amount is released.

When a telephony system operates as described above, there is very little message traffic passing back and forth between the elements of the telephony system responsible for setting up and providing the requested telephony services, and the elements responsible for managing and charging a prepaid account. When the request for new telephony services is first received, there is an initial exchange to determine how much of the current balance of a prepaid account to reserve. But once that exchange is accomplished, and the elements of the telephony system responsible for setting up and providing the telephony services have been informed of the amount that has been reserved, there is no need for any additional message traffic until the accrued charges for providing the telephony services exceed the original reserved amount, or until the telephony services are terminated. This greatly reduces the message traffic that would otherwise be required to manage the balance of the prepaid account.

Also, with a method as described above, the telephony system can be providing telephony services to multiple different users simultaneously, all of whom will charge the same prepaid account for those telephony services. In each case, before telephony services are provided to a user, a portion of the balance of the prepaid account is reserved to pay for the telephony services that are to be provided to the user. Thus, if first, second and third users are all simultaneously receiving telephony services from the telephony system using the same prepaid account, first, second and third portions of the balance of the prepaid account will have been reserved for the first, second and third users, respectively. After the initial exchange used to establish the first, second and third reservations, there is no need for further communications with the prepaid account management unit until the accrued charges made by one of the users exceeds his original reserved amount, or until one of the telephony communications is terminated and it is time to actually charge the prepaid account. Because different portions of the original balance of the prepaid account are reserved for each of the users, there is no need to constantly communicate with the prepaid account management unit to prevent the charges for the telephony services provided to one of the users from consuming the entire balance of the prepaid account while telephony services are still being provided to other users.

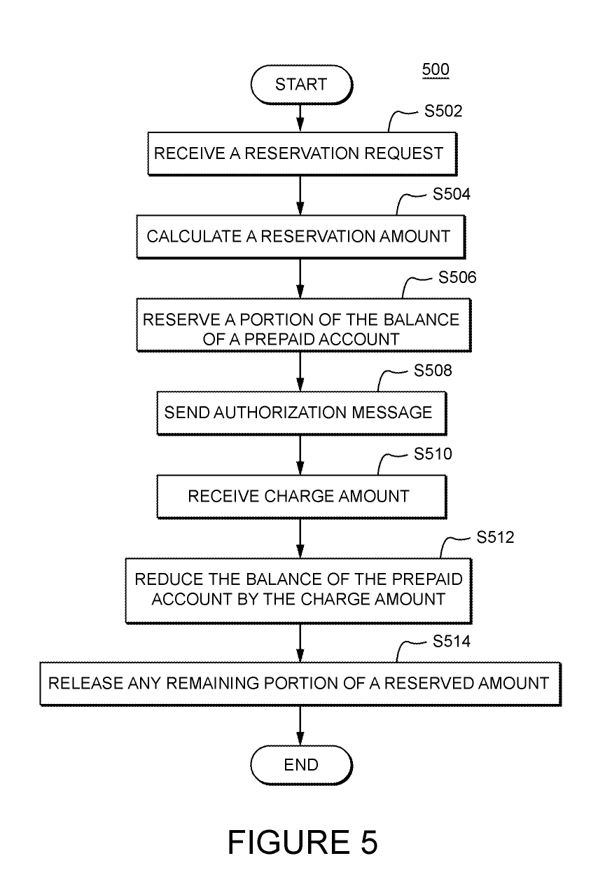

FIG. 5 illustrates a first method 500 that would be performed by a prepaid account management unit 310 to manage charges applied to a prepaid account for telephony services provided to a first user. The method 500 begins and proceeds to step S502, where the reservation unit 314 of a prepaid account management unit 310 receives a reservation request from a prepaid account charge unit 410, as illustrated in FIG. 4. This would occur because a user has requested new telephony services that are to be paid for by a prepaid account, or possibly because a telephony system is attempting to connect an incoming telephony communication to a user's telephony device, and the user will need to pay for that incoming telephony communication via a prepaid account. In such circumstances, one or more elements of a telephony system would send a request to the prepaid account management unit 310 requesting authorization to provide the requested services, and requesting that a portion of the balance of the user's prepaid account be reserved to pay for the requested services. Such a reservation request could be received from a proxy server, a gateway, or some other element responsible for setting up and/or providing the requested telephony services. Alternatively, in some embodiments, such a reservation request could be received directly from a user's telephony device.

In some embodiments, the received reservation request could specify the portion of the balance of the prepaid account that is to be reserved. In alternate embodiment, in step S504, the reservation unit 314 calculates or determines the portion of the balance of the prepaid account to reserve for the requested telephony services. Thus, step S504 is an optional step that is performed in instances where the received reservation request does not specify the portion of the balance of the prepaid account that is to be reserved.

When the reservation unit 314 determines or calculates the portion of the balance of the prepaid account that is to be reserved, the determination or calculation could be accomplished in many different ways. In some instances, the amount that is reserved could be a percentage of the total current balance of the prepaid account, up to some maximum amount. Likewise, there might be a minimum amount that must be reserved, regardless of the actual balance in the prepaid account.

As will be described in more detail below, where the balance of the prepaid account is used to determine the amount which is to be reserved to pay for a particular requested telephony service, the balance that is used should be the unreserved balance of the prepaid account. In other words, if portions of the balance have already been reserved to pay for telephony services requested by other users, the balance that is considered should be the unreserved portion of the balance of the prepaid account.

In other instances, the amount that is reserved could be based on anticipated charges for the requested telephony services. In the case of a request to setup a new telephone call, the anticipated charges will vary depending on the per minute rate for conducting the telephone call, and the per minute rate will vary depending on where the call is directed. Thus, the amount of the balance that is to be reserved could be the anticipated charges for a predetermined number of minutes at whatever the per minute rate is for the requested telephone call.

In other instances, where the requested telephony service is charged at a flat rate, the amount of the balance that is reserved could still be based on anticipated charges, but the amount could be calculated in a very different way. For example, if the requested telephony service is a text or SMS message, and there is a flat rate charge for sending and/or receiving text or SMS messages, the portion of the balance of the prepaid account that is to be reserved could be calculated based on the charge for providing a predetermined number of text or SMS messages. The portion of the balance that is to be reserved is for providing multiple text or SMS messages because one recognizes that when a first text message is sent or received, multiple text messages will probably pass back and forth before the exchange is completed. Also, here again, the identity or location of the party to which a text or SMS message is sent could affect the flat rate charge for providing the service.

When information about the per minute rate and/or flat rate charges for providing the requested telephony services is used to calculate or determine the amount of the balance of the prepaid account to reserve, this information could be provided as part of the reservation request that is received in step S502. In other embodiments, the reservation unit 314 could obtain this information from alternate sources. However, if the information is to be obtained from alternate sources, the received reservation request may need to include information about the requested telephony services that allow the reservation unit 314 to determine the correct per minute rate or flat rate charge.

In still other embodiments, information about past telephony service usage may be taken into account in determining or calculating the amount of the balance of a prepaid account which is to be reserved. For example, when a particular user requests the setup of a new telephone call to a particular party, the reservation unit 314 may review historical data about previous calls made by the user which is stored in a historical database 530. If the user has made multiple calls to the same party in the past, the typical or average length of the previous calls could be used to estimate the duration of time that the user is likely to talk to the party during the presently requested telephone call. The estimated duration, in combination with the per minute rate for the telephone call, is used to estimate the likely charge for the requested call. This amount, or slightly more than that amount, could be the portion reserved from the balance of the prepaid account.

In other instances, the average duration of calls that the user has made to the same location in the past could be used to estimate the duration of the requested call. Similarly, if the requested call is to a particular type of business, the average duration of previous calls made to similar businesses could be used to estimate the duration of the requested call. In fact, the data stored in the historical database 330 could be used in many different ways to estimate the duration of the requested call, and the estimated duration is then used to determine how much of the balance of the prepaid account to reserve to cover the anticipated cost of the requested call.

In some embodiments, the information about past calls my not be information about past calls made by the same user that is requesting a new call, but rather information about all calls made by all users to the same destination area. For example, the historical database 330 could be consulted to determine the average duration of all calls made to the same destination, and that average duration could be used to calculate how much of the balance of the prepaid account to reserve to cover the anticipated cost of the requested call.

In other embodiments, the determination of the anticipated length of the requested call could be based on an even more complex calculation. For example, the formula for calculating the anticipated duration could be W1×(the upper 20% of the average duration for all calls to the destination)+W2×(the median duration of all calls to the destination)+W3×(the lower 20% of the average duration of calls to the destination). The variables W1, W2 and W3 could be adjusted over time to try to bring the calculated anticipated duration in line with the actual events. Of course, many other formula could also be used to calculate the anticipated duration of a requested call, and that anticipated duration could then be used to determine how much of the balance of a prepaid account to reserve to cover the anticipated cost of the requested call.

Information in the historical database 330 could also be used to estimate the charges that will result when the user requests telephony services that are charged on a flat fee basis, such as text or SMS messages. The historical database 330 may include information that indicates the typical or average number of text messages that the user exchanges with other parties when engaging in a text message conversation. This information could also be used to determine how much of the balance of a prepaid account to reserve to pay for requested telephony services that are charged on a flat fee basis.

Returning now to the method illustrated in FIG. 5, once the amount to reserve from the balance of the prepaid account has been determined or calculated in step S504, the method proceeds to step S506, where that amount of the balance is reserved by the reservation unit 314. In some instances, the method then proceeds to step S508, where the reservation unit 314 sends an authorization message to one or more elements of the telephony system responsible for setting up and/or conducting the requested telephony service. The authorization message indicates that there is a sufficient balance in the prepaid account for the telephony system to begin providing the requested telephony services. In some embodiments, the authorization message will also indicate the amount of the prepaid account which has been reserved. However, in alternate embodiments, such as where the original reservation request indicated the amount that was to be reserved, the authorization message may not include the actual amount of the balance that was reserved. Also, the entire authorization step is optional, and may not be performed in some embodiments.

At this point, one or more elements of the telephony system will begin to provide the requested telephony services to the user. As will be described below, as the telephony services are provided, one or more elements of the telephony system will monitor the accrued charges for providing the telephony services to ensure that the accrued charges do not exceed the amount of the balance that was reserved. If the telephony services are ultimately terminated before the accrued charges exceed the reserved amount, the elements responsible for providing the requested telephony services send a message to the charge unit 318 of the prepaid account management unit 310 indicating the final charge for providing the telephony services, and that message is received in step S510.

In step S512, the charge unit 318 reduces the balance of the prepaid account by the amount of the final charge for providing the telephony services. In step S514, the reservation unit releases any portion of the original reserved amount of the balance of the prepaid account that exceeds the actual final charges for providing the requested telephony services. This frees up of the released portion of the balance so that it can be reserved in connection with other requests for telephony services. The method then ends.

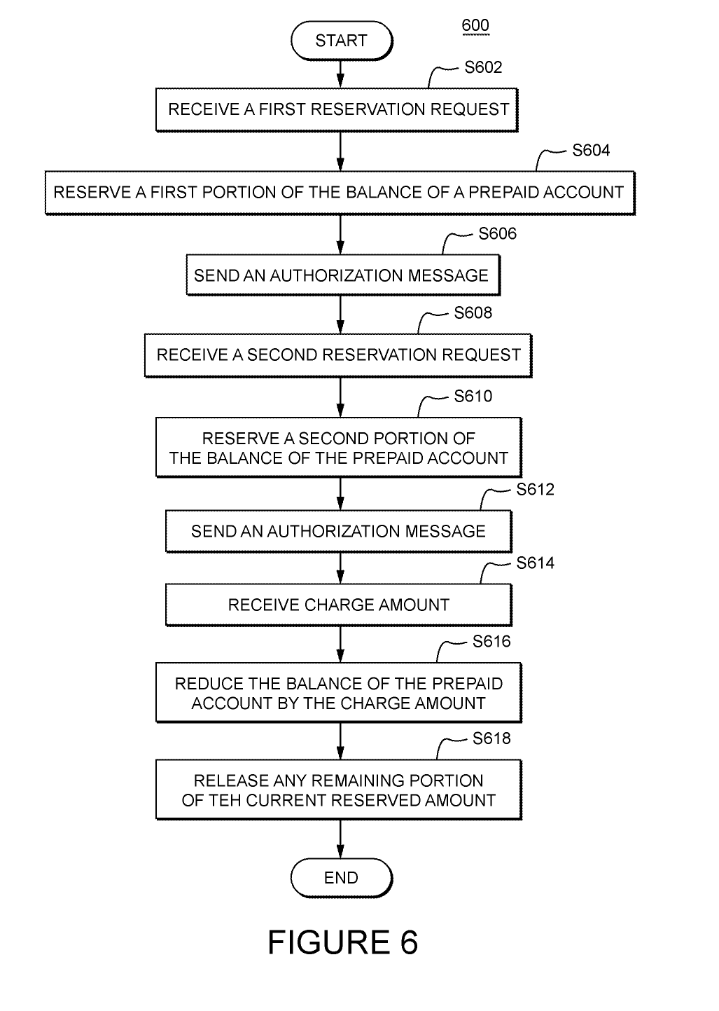

FIG. 6 illustrates steps of an alternate method 600 that is performed by the prepaid account management unit 310 when the first reserved portion of the balance of the prepaid account is not sufficient to cover the entire charge for the telephony services that are ultimately provided to the user. The method 600 begins and proceeds to step S602, where the reservation unit 314 receives a first reservation request. As discussed above, the first reservation request may include the amount of the balance of the prepaid account that is to be reserved. Alternatively, the reservation unit 314 may determine or calculate the amount of the balance that is to be initially reserved. Regardless, once the amount is determined, the reservation unit 314 reserves the determined amount in step S604. In step S606, the reservation unit sends an authorization message to one or more elements of the telephony system responsible for setting up and/or providing the requested telephony services indicating that it is OK to begin providing the requested telephony services. As also noted above, this authorization message may include the reserved amount.

At this point, one or more elements of the telephony system will begin to provide the requested telephony service to the user. As explained above, the accrued charges for providing the telephony service are monitored as the telephony services are provided. If the accrued charges approach the originally reserved amount, there is a danger that continuing to provide the telephony service will result in the charges exceeding the first reserved amount. And if that occurs, there is a danger that there will not be enough of a balance in the prepaid account to cover the total charge for providing the telephony services. For this reason, when the accrued charges approach the first reserved amount, one or more elements of the telephony system responsible for setting up and/or providing the telephony services send a second reservation request to the reservation unit 314. In step S608 of the method illustrated in FIG. 6, the second reservation request is received by the reservation unit 314.

Here again, the second reservation request could specify a second portion of the unreserved balance of the prepaid account that is to be reserved. Alternatively, the reservation unit 314 could determine or calculate a second amount that is to be reserved. In step S610, the second portion of the balance of the prepaid account is reserved. Then, in step S612, the reservation unit 314 sends a second authorization message to one or more elements of the telephony system responsible for setting up and/or providing the telephony service. The second authorization message could also include the second reserved amount, or it could indicate the sum of the first and second reserved portions. The second authorization message will indicate that it is OK to continue providing the telephony services until the accrued charges approach the combined first and second reserved amounts.

Of course, it is also possible that when the reservation unit 314 receives the second reservation request, it determines that the balance of the prepaid account is not sufficient to cover any additional charges. If that is the case, the reservation unit 314 may send a message to one or more elements of the telephony system responsible for setting up and/or providing the telephony services indicating that the telephony services should be cut off when the accrued charges reach the original, first reserved amount. Alternatively, the message may indicate the amount of any additional portion of the balance of the prepaid account which is available. In which case, the telephony services could continue to be provided until the accrued charges equal the sum of the original reserved amount, plus the additional amount which is available.

In yet other embodiments, when the reservation unit 314 determines that there is not enough additional value in the prepaid account to reserve a second portion of the prepaid account balance, an element of the prepaid account management unit 310 may act to add additional value to the prepaid account. For example, the individual who setup the prepaid account may have provided standing instructions to charge a credit card when the balance falls below a threshold level to add a certain amount of value to the prepaid account. If that is the case, and if the reservation unit 314 receives a reservation request that cannot be fulfilled based on the existing balance of the prepaid account, value is first added to the prepaid account. After the balance of the prepaid account has been increased, the reservation unit 314 acts on the reservation request. The process of adding value to a prepaid account could occur when the reservation unit 314 receives a first reservation request, or when the reservation unit 314 receives a subsequent reservation request after telephony services are already being provided to a user.

Although the method illustrated in FIG. 6 only includes the receipt of two reservation requests, in alternate embodiments, additional reservation requests could be received if the accrued charges for the telephony services approach the sum of the first and second reserved amounts. However, eventually the telephony services will be terminated. At that point, in step S614, the charge unit 318 will receive a message indicating the final charge for providing the requested telephony services. In step S616, the charge unit 318 reduces the balance of the prepaid account by the amount of the final charge for providing the telephony services. In step S618, the reservation unit 314 releases any portion of the current reserved amount of the balance of the prepaid account that exceeds the actual final charges for providing the requested telephony services. This frees up of the released portion of the balance so that it can be reserved in connection with other requests for telephony services. The method then ends.

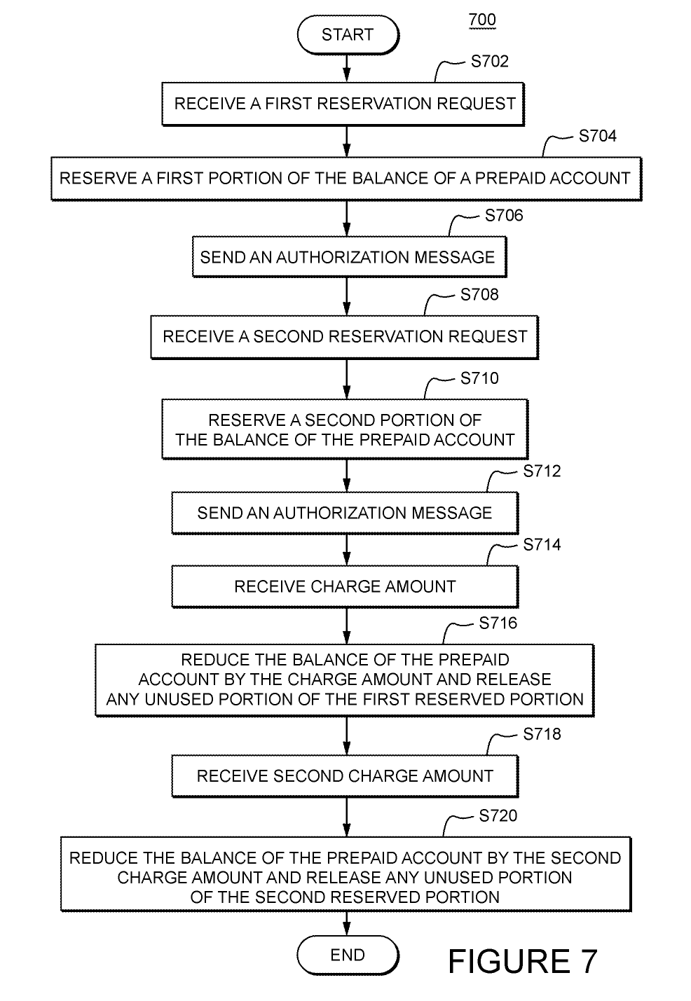

FIG. 7 illustrates steps of another method 700 that can be performed by the prepaid account management unit 310 when two separate users request telephony services that are to be provided at the same time, and which are to be paid for by the same prepaid account. The method 700 begins and proceeds to step S702 where the reservation unit 314 receives a first request to reserve a first portion of the balance of a prepaid account which is to be used to pay for telephony services requested by a first user. In step S704 the reservation unit 314 reserves the first portion of the balance of the prepaid account. As discussed above, the reservation request could specify the first amount that is to be reserved, or the reservation unit 314 could determine or calculate the first portion that is to be reserved based on any of multiple methods. In step S706 an authorization message is sent to one or more elements of the telephony system responsible for setting up and/or providing the telephony services requested by the first user to indicate that it is OK to begin providing the requested telephony services. At this point, the telephony system will begin to provide the requested telephony services to the first user.

In step S708, the reservation unit 314 receives a second reservation request to reserve a second portion of the unreserved balance of the same prepaid account which is to be used to pay for telephony services that have been requested by a second user. In step S710, the reservation unit 314 reserves the second portion of the unreserved balance. In step S712, an authorization message is sent to one or more elements of the telephony system responsible for setting up and/or providing the telephony services to the second user.

At this point, various elements of the telephony system are providing the requested telephony services to the first and second users. Those elements of the telephony system also track the respective accrued charges for providing the telephony services to each of the first and second users. If the accrued charges for providing the telephony services to either of the first and second users comes close to exceeding the corresponding reserved portion of the balance of the prepaid account, an additional reservation request is sent to the reservation unit 314 to reserve an additional portion of the unreserved balance of the prepaid account, as discussed above in connection with the method illustrated in FIG. 6. On the other hand, if the accrued charges for the telephony services provided to the first and second users never exceed the corresponding reserved amounts before the telephony services are terminated, the method will proceed as illustrated in FIG. 7.

Once the telephony services provided to the first user are terminated, in step S714 the charge unit 318 of the prepaid account management unit 310 receives a message indicating the final charge to be applied for providing the telephony services to the first user. In step S716, the charge unit 318 reduces the balance of the prepaid account by the amount of the first charge, and any remaining portion of the amount reserved for the first user is released.

Once the telephony services provided to the second user are terminated, in step S718 the charge unit 318 of the prepaid account management unit 310 receives a message indicating the final charge to be applied for providing the telephony services to the second user. In step S720, the charge unit 318 reduces the balance of the prepaid account by the amount of the second charge, and any remaining portion of the amount reserved for the second user is released. The method then ends.

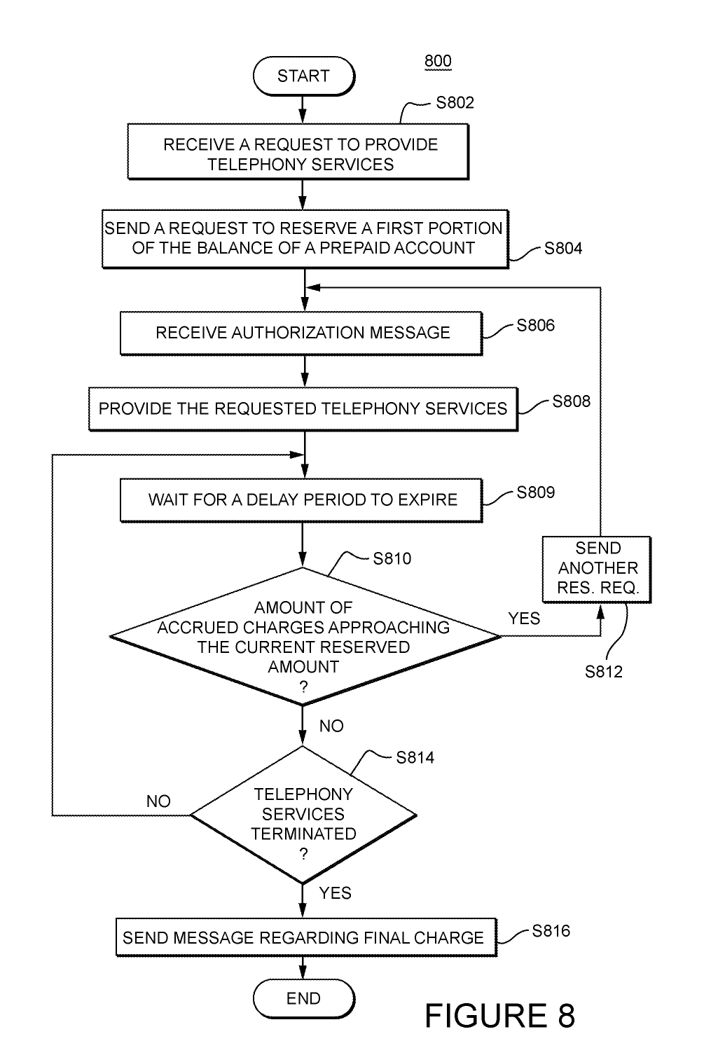

The above-discussed methods are performed by the prepaid account management unit 310 to reserve certain portions of the balance of a prepaid account when new telephony services are requested, and to ultimately charge the prepaid account once the telephony services have been terminated. The method illustrated in FIG. 8 and discussed below is performed by a prepaid account charge unit 410, as illustrated in FIG. 4. Some or all of the elements of the prepaid account charge unit 410 could be present in one or more elements of a telephony system responsible for setting up and/or providing telephony services to a user. Some or all of the elements of the prepaid account charge unit 410 may also be present in a user's telephony device. The steps of the method illustrated in FIG. 8 facilitate the charging of a prepaid account to pay for telephony services requested by the user.

The method 800 begins and proceeds to step S802, where one or more elements of a telephony system receive a request for new telephony services from a user, and where the services are to be paid for via a prepaid account. In step S804, a reservation request unit 412 of the prepaid account charge unit 410 sends a reservation request to a reservation unit 314 of a prepaid account management unit 310. The reservation request could include very little information, such as only an identification of the prepaid account itself. On the other hand, the reservation request could include several items of information that are helpful in reserving a portion of the prepaid account to pay for the requested telephony services.

In some embodiments, the reservation request could simply state the portion of the prepaid account that is to be reserved. If this is the case, a reservation calculation unit 416 of the prepaid account charge unit 410 could determine or calculate the amount to be reserved. The method used to calculate the amount that is to be reserved could be any of the methods discussed above, or other methods.

The reservation request also could include information about the requested telephony services that help the reservation unit 314 of the prepaid account management unit 310 to calculate or determine the amount which is to be reserved. For example, the reservation request could indicate the per minute rate which is to be charged for a requested telephone call, or a flat rate which is to be charged for telephony services such as text or SMS messages. Other forms of information about the charges which will be applied for providing the telephony services could also be provided.

In other embodiments, the information in the reservation request could enable the reservation unit 314 to determine the per minute rate that is to be charged, or a flat rate that is to be charged. For example, the information in the reservation request could identify the user, indicate that the user is located in the United States, and that the user has requested a telephone call to a telephone number in China. Based on this information, the reservation unit 314 could determine the per minute rate that is to be charged for the requested telephone call.

In still other embodiments, the information in the reservation request could provide an estimate of an anticipated duration of a requested telephone call. This duration estimate could be based on historical data that is available to the element of the telephony system sending the reservation request, such as the historical database 330. Similarly, the reservation request could provide an estimate of the number of flat fee items the user is likely to need or use, such as the number of text messages the user is likely to send. Here again, this information could be based on historical data.

As discussed above in connection with the methods illustrated in FIGS. 5-7, a reservation unit 314 of a prepaid account management unit 310 will reserve a portion of a balance in the prepaid account, then an authorization message is sent. In the method illustrated in FIG. 8, the authorization message is received by the reservation request unit 412 in step S806. The authorization message indicates that it is OK to being providing the requested telephony services. The authorization message may also indicate the amount of the balance of the prepaid account that has been reserved. The method then proceeds to step S808, where one or more elements of the telephony system begin providing the requested telephony services. The method then proceeds to step S809, where a delay period is allowed to expire. The delay period is introduced to avoid comparing the accrued charges to the reserved amount more frequently than necessary.

As the telephony services are provided to the user, a charge tracking unit 414 monitors the accrued charges for providing the telephony services. Periodically, in step S810, the charge tracking unit 414 performs a check to determine if the accrued charges are approaching the current reserved amount. The way in which this check is performed could vary. For example, in some embodiments, a check is performed to determine if the accrued charges exceed 90% of the current reserved amount. In alternate embodiments, such as where the user is conducting a telephone call, the check performed in step S810 could involve determining if the accrued charges have used all but 5 minutes worth of the current reserved amount of the balance of the prepaid account. Of course, in other embodiments, the check performed in step S810 could be performed in other ways, and the thresholds used to determine if the accrued charges are approaching the current reserved amount could vary.

If the check performed in step S810 indicates that the accrued charges are not approaching the current reserved amount, the method proceeds to step S814, and a check is performed to determine if a party to the telephony services has requested that the telephony services be terminated. If not, the method loops back to step S809, and another delay period is allowed to expire while the telephony services are still being provided. The method then proceeds to step S810, where another check is performed by the charge tracking unit 414 to determine if the accrued charges are approaching the current reserved amount.

If a check performed in step S810 indicates that the accrued charges for providing the telephony services are approaching the current reserved amount, the method proceeds to step S812, and another reservation request is sent by the reservation request unit 412 to the reservation unit 314. The new reservation request will ask that an additional portion of the unreserved balance of the prepaid account be reserved to pay for the telephony services that are being provided. Assuming the reservation unit 314 is able to reserve an additional portion of the unreserved balance of the prepaid account, the method will continue to step S806, and a new authorization message is received from the reservation unit 314. The method then proceeds on to steps S808, S809 and S810. In this case, further iterations of the performance of step S810 will determine if the current accrued charges are approaching the new reserved amount, which is the sum of the original amount and any subsequently reserved amounts.

If the reservation unit 314 determines that there is no longer enough of an unreserved balance to make another reservation, and it is not possible to add value to the prepaid account, the reservation unit will instruct the elements providing the telephony services to provide a warning, and to thereafter terminate the telephony services.

If performance of the check in step S814 indicates that the telephony services are to be terminated, or have already been terminated, the method proceeds to step S816, where the charge tracking unit 414 sends a message to the charge unit 318 of the prepaid account management unit 310 indicating the final charge for providing the telephony services. This information allows the charge unit 318 to reduce the balance of the prepaid account by the amount of the final charge, and allows any unused portion of the current reserved amount to be released. The method then ends.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.”

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of managing a prepaid account used to purchase telephony services, comprising:
receiving a request to reserve a first portion of a balance of a prepaid account which is to be used to pay for a first requested telephony service;
reserving the first portion of the balance of the prepaid account;
receiving information that is indicative of a first charge to be applied for the first telephony service after the first telephony service has been provided;
reducing the balance of the prepaid account by the amount of the first charge; and
releasing any portion of a previously reserved amount for the first requested telephony service that exceeds the amount of the first charge.

2. The method of claim 1, further comprising:
receiving a request to reserve a second portion of the balance of the prepaid account which is to be used to pay for the first requested telephony service; and
reserving the second portion of the balance of the prepaid account.

3. The method of claim 2, wherein the request to reserve a second portion of the balance of the prepaid account is received after an accrued charge for providing the first requested telephony service has increased to become within a predetermined amount of the reserved first portion of the balance

4. The method of claim 1, further comprising:
receiving a request to reserve a second portion of the balance of the prepaid account which is to be used to pay for a second requested telephony service;
reserving the second portion of the balance of the prepaid account.

5. The method of claim 4, further comprising:
receiving information that is indicative of a second charge to be applied for the second telephony service after the second telephony service has been provided;
reducing the balance of the prepaid account by the amount of the second charge; and
releasing any portion of a previously reserved amount for the second requested telephony service that exceeds the amount of the second charge.

6. The method of claim 1, wherein the received request to reserve a first portion of a current balance of a prepaid account includes the amount of the first portion.

7. The method of claim 1, wherein the received request to reserve a first portion of the balance of a prepaid account includes information about the first requested telephony service.

8. The method of claim 7, wherein the received request to reserve a first portion of the balance of the prepaid account includes information indicative of a per minute charge or a flat fee which is to be charged for providing the first requested telephony service.

9. The method of claim 1, further comprising determining an amount of the first portion of the balance of the prepaid account.

10. The method of claim 9, wherein the amount of the first portion is determined based on information indicative of a per minute charge or a flat fee which is to be charged for providing the first requested telephony service.

11. The method of claim 9, wherein the amount of the first portion is determined based on the current balance of the prepaid account.

12. The method of claim 9, wherein the amount of the first portion is determined based on the current unreserved balance of the prepaid account.

13. The method of claim 9, wherein the amount of the first portion is determined based on information indicative of past telephony service usage patterns of the party to whom the first requested telephony services are to be provided.

14. The method of claim 9, further comprising adding value to the prepaid account when an unreserved balance of the prepaid account falls below a predetermined threshold amount.

15. The method of claim 14, wherein adding value to the prepaid account comprises charging a credit card to add value to the prepaid account.

16. The method of claim 1, further comprising sending a message indicating that the first portion of the balance of the prepaid account has been reserved.

17. The method of claim 16, wherein sending a message comprises sending a message that indicates an amount of value of the first portion.

18. The method of claim 1, further comprising sending a message authorizing the first requested telephony to be provided until accrued charges for providing the first requested telephony service have increased to become within a predetermined portion of the reserved first portion of the balance of the prepaid account.

19. A system for managing a prepaid account used to purchase telephony services, comprising:
means for receiving a request to reserve a first portion of a balance of a prepaid account which is to be used to pay for a first requested telephony service;
means for reserving the first portion of the balance of the prepaid account;
means for receiving information that is indicative of a first charge to be applied for the first telephony service after the first telephony service has been provided;
means for reducing the balance of the prepaid account by the amount of the first charge; and
means for releasing any portion of a previously reserved amount for the first requested telephony service that exceeds the amount of the first charge.

20. A system for managing a prepaid account used to purchase telephony services, comprising:
a reservation unit configured to receive a request to reserve a first portion of a balance of a prepaid account which is to be used to pay for a first requested telephony service and that reserves the first portion of the balance of the prepaid account;
a charging unit configured to receive information that is indicative of a first charge to be applied for the first telephony service after the first telephony service has been provided, that reduces the balance of the prepaid account by the amount of the first charge, and that releases any portion of a previously reserved amount for the first requested telephony service that exceeds the amount of the first charge.
